(19) United States
(12) Patent Application Publication
(10) Pub. No.: US 2006/0139607 A1
(43) Pub. Date: Jun. 29, 2006

(54) Lithographic apparatus and device manufacturing method

(75) Inventors: Richard Joseph Bruls, Eindhoven (NL); Robertus Cornelis Martinus De Kruif, Eindhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/019,535

(22) Filed: Dec. 23, 2004

(51) Int. Cl. G03B 27/72

(52) U.S. Cl. 355/69; 355/53

(57) ABSTRACT

Projection beam bandwidth contributes to optical proximity curve/Iso-Dense bias of a system, and can vary from one system to another. This can result in proximity mis-match between systems. The invention addresses this problem by providing a lithographic apparatus comprising: an illumination system for providing a projection beam of radiation; the projection beam with a pattern in its cross-section; a substrate table for holding a substrate; and a projection system for projecting the patterned beam onto a target portion of the substrate, wherein there are provided means for modifying the projection beam bandwidth distribution.

### BACKGROUND OF THE INVENTION

1. Field of the Invention

The present invention relates to a lithographic apparatus and a device manufacturing method. This invention also relates to a device manufactured thereby.

2. Background of the Related Art

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g., comprising part of, one or several dies) on a substrate (e.g., a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the projection beam in a given direction (the “scanning”-direction) while synchronously scanning the substrate parallel or anti-parallel to this direction.

Between the reticle and the substrate is disposed a projection system for imaging the irradiated portion of the reticle onto the target portion of the substrate. The projection system includes components for directing, shaping or controlling the projection beam of irradiation, and these components typically include refractive optics, reflective optics, and/or catadioptric systems, for example.

Generally, the projection system comprises optical components to set the numerical aperture (commonly referred to as the “NA”) of the projection system. For example, an adjustable NA-diaphragm is provided in a pupil of the projection system. The illumination system typically comprises adjustable optical elements for setting the outer and/or inner radial extent (commonly referred to as σ-outer and σ-inner, respectively) of the intensity distribution upstream of the mask (in a pupil of the illumination system). A specific setting of σ-outer and σ-inner may be referred to hereinafter as an annular illumination mode. Controlling the spatial intensity distribution at a pupil plane of the illumination system can be done to improve the processing parameters when an image of the illuminated object is projected onto a substrate.

Microchip fabrication involves the control of tolerances of a space or a width between devices and interconnecting lines, or between features, and/or between elements of a feature such as, for example, two edges of a feature. In particular the control of space tolerance of the smallest of such spaces permitted in the fabrication of the device or IC layer is of importance. Said smallest space and/or smallest width is referred to as the critical dimension (“CD”).

With conventional projection lithographic techniques it is well known that an occurrence of a variance in CD for isolated features and dense features may limit the process latitude (i.e., the available depth of focus in combination with the allowed amount of residual error in the dose of exposure of irradiated target portions for a given tolerance on CD). This problem arises because features on the mask (also referred to as reticle) having the same nominal critical dimensions will print differently depending on their pitch on the mask (i.e., the separation between adjacent features) due to pitch dependent diffraction effects. For example, a feature consisting of a line having a particular line width when in isolation, i.e. having a large pitch, will print differently from the same feature having the same line width when together with other lines of the same line width in a dense arrangement on the mask, i.e., having small pitch. Hence, when both dense and isolated features of critical dimension are to be printed simultaneously, a pitch dependent variation of printed CD is observed. This phenomenon is called “iso-dense bias,” and is a particular problem in photolithographic techniques. Iso-dense bias is typically measured in nanometers and represents an important metric for practical characterization of lithography processes.

‘Proximity bias’ or ‘CD-bias’ or ‘pitch-bias’ is the difference in CD between two lines at a different pitch. Pitch is the sum of the feature width and the space between two subsequent features. Exposure tool to tool difference can cause this difference not to be zero. One of the contributors can be a difference in projection beam or laser bandwidth and/or difference in projection beam or laser bandwidth asymmetry.

Conventional lithographic apparatus do not directly address the problem of iso-dense bias. Conventionally, it is the responsibility of the users of conventional lithographic apparatus to attempt to compensate for the iso-dense bias by either changing the apparatus optical parameters, such as the NA of the projection lens or the σ-outer and σ-inner settings, or by designing the mask in such a way that differences in dimensions of printed isolated and dense features are minimized.

Generally, in a high volume manufacturing site different lithographic projection apparatus are to be used for the same lithographic manufacturing process step to ensure optimal exploitation of the machines, and consequently (in view of, for example, machine-to-machine differences) a variance and/or errors in CD may occur in the manufacturing process. Generally, the actual pitch dependency of such errors depends on the specific layout of the pattern and the features, the aberration of the projection system of the lithographic apparatus in use, the properties of the radiation sensitive layer on the substrate, and the radiation beam properties such as illumination settings, and the exposure dose of radiation energy, and laser bandwidth and laser bandwidth symmetry. Therefore, given a pattern to be provided by a patterning device, and to be printed using a specific lithographic projection apparatus including a specific radiation source, one can identify data relating to iso-dense bias which are characteristic for that process, when executed on that lithographic system. In a situation where different lithographic projection apparatus (of the same type and/or of different types) are to be used for the same lithographic manufacturing process step, there is a problem of mutually matching the corresponding different iso-dense bias characteristics, such as to reduce CD variations occurring in the manufacturing process. Another technique would be to vary NA. Again the problem would be the impact on the process latitude.

A known technique to match an iso-dense bias characteristic of a machine (for a process whereby an annular illumination mode is used) to an iso-dense bias characteristic of another machine is to change the σ-outer and σ-inner settings, while maintaining the difference between the σ-outer and σ-inner settings (i.e., whilst maintaining the annular ring width of the illumination mode) of one of the two machines. The nominal σ-settings are chosen so as to optimize the process latitude (in particular, the depth of focus and the exposure latitude). Therefore, this approach has the disadvantage that for the machine whereby the σ-settings are changed, the process latitude is becoming smaller and may become too small for practical use.

U.S. Patent Publication No. 2002/0048288A1 (CYMER) relates to an integrated circuit lithographic technique for controlling bandwidths wherein the laser beam bandwidth is controlled to produce an effective beam spectrum having at least two spectral peaks in order to produce improved pattern resolution in photo-resist film. U.S. Patent Publication No. 2002/0048288A1 is incorporated herein by reference.

U.S. Pat. No. 5,303,002 (INTEL) relates to a method and apparatus for patterning a photo-resist layer wherein a plurality of bands of radiation are used to provide an enhanced depth of focus. U.S. Pat. No. 5,303,002 is incorporated herein by reference.

The present inventors have identified the following. The finite size of the projection beam or laser bandwidth introduces a smear out of the range of a feature over a focus range around a best focus position in the resist (dF/dλ=C, where F=focus, λ=wavelength and C=a constant). In other words, when, for example, a drawing shows an axis in “Focus (μm),” this could be replaced by “wavelength (μm).” This has an effect on the image contrast at wafer level. As such, laser bandwidth contributes to the optical proximity effects and the proximity curve/iso-dense bias of a system (see FIG. 4). The laser bandwidth can vary from system to system. As a result the proximity behaviour and this imaging performance can differ from system to system resulting in a proximity mis-match.

One aspect of embodiments of the present invention obviates or mitigates one or more of the aforementioned problems in the prior art.

It is a further aspect of at least one embodiment the present invention to enable modification of the laser bandwidth, reduce the difference in proximity and/or match two systems for optical proximity differences introduced by the laser bandwidth differences.

It is a further aspect of at least one embodiment of the present invention to use an asymmetric bandwidth to correct for iso-dense bias.

### SUMMARY OF THE INVENTION

According to an aspect of the invention there is provided a lithographic apparatus including an illumination system for providing a projection beam of radiation, a support structure for supporting a patterning device, the patterning device serving to impart the projection beam with a pattern in its cross-section, a substrate table for holding a substrate, and a projection system for projecting the patterned beam onto a target portion of the substrate, wherein there is provided a system for modifying the projection beam distribution.

The present invention therefore provides an advantage of projection beam modification to match system to system optical proximity behavior.

The projection beam distribution may be a projection beam or laser bandwidth distribution or wavelength distribution.

In a particular application, the modifying system increases the projection beam bandwidth distribution, in use.

The modifying system may, in use, cause a symmetrical projection beam bandwidth distribution to become asymmetrical.

In particular, the projection beam distribution control may include control of the distribution to improving system to system imaging performance.

The modifying system may be manually controllable.

The projection beam distribution may be modified by superimposing two wavelength spectra with a wavelength difference, substantially the same bandwidth and the same intensity. This may provide a symmetrical modification.

The projection beam may be modified by:

superimposing two wavelength spectra having a wavelength difference with different bandwidth and substantially the same intensity;

superimposing two wavelength spectra having a wavelength difference and with substantially the same bandwidth and different intensities;

superimposing two wavelength spectra having a wavelength difference, different bandwidth and different intensities.

The wavelength difference may be between 0 and 1 pm or 0 and 0.5 pm and in a particular embodiment, around smaller than 1 pm or 0.5 pm.

The bandwidth (E95) may be between 0 and 1.0 pm and in particular around 0.5 pm.

The intensity×wavelength shift ratio between the left and right side of the wavelength distribution with respect to the centre of the total wavelength range (as determined based on E95) should be 1.1≦|I_{left}|/|I_{right}| or 0.9≧|I_{left}|/|I_{right}| (and in particular with
I_{left}=∫Δλₗ×Iₗ(Δλₗ)dΔλₗ and I_{right}=∫Δλᵣ×Iᵣ(Δλᵣ)dΔλᵣ)
in order to say a distribution is asymmetric.

The projection beam distribution may comprise at least two wavelength spectra which may be exposed upon the substrate, in a particular embodiment, substantially simultaneously or, alternatively, sequentially.

The radiation used may have a wavelength in the Deep Ultra-Violet (DUV).

The radiation used may have a wavelength of about 20 to 50 nm, 50 to 500 nm, or about 100 to 400 nm.

The radiation may have a wavelength of about 126 nm, 157 nm, 193 nm, 248 nm or 365 nm.

The radiation used may have a wavelength in the extreme ultra-violet (EUV), e.g., having a wavelength in the range of about 5 to 20 nm.

The radiation may have a wavelength of about 13.5 nm.

A projection beam or radiation source(s) may be a laser. For example, the radiation source may be an excimer laser.

According to another aspect of the invention there is provided a lithographic apparatus including a system for modifying a projection beam distribution.

According to a further aspect of the invention, there is provided a device manufacturing method comprising, providing a substrate, providing a projection beam of radiation using an illumination system, using a patterning device to impart the projection beam with a pattern in its cross-section and projecting the patterned beam of radiation onto a target portion of the substrate, wherein the method further includes modifying the projection beam distribution.

Wherein the modification step can be carried out within the illumination system.

According to a further aspect of the invention there is provided a device manufactured according to the above-referenced device manufacturing method and/or by the above-referenced lithographic apparatus.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g., having a wavelength of 365, 248, 193, 157 or 126 nm) and extreme ultra-violet (EUV) radiation (e.g., having a wavelength in the range of 5-20 nm), as well as particle beams, such as ion beams or electron beams.

The term “patterning device” used herein should be broadly interpreted as referring to devices that can be used to impart a projection beam with a pattern in its cross-section such as to create a pattern in a target portion of the substrate. It should be noted that the pattern imparted to the projection beam may not exactly correspond to the desired pattern in the target portion of the substrate. Generally, the pattern imparted to the projection beam will correspond to a particular functional layer in a device being created in the target portion, such as an integrated circuit.

Patterning devices may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. The support structure supports, i.e., bears the weight of, the patterning device. It holds the patterning device in a way depending on the orientation of the patterning device, the design of the lithographic apparatus, and other conditions, such as for example whether or not the patterning device is held in a vacuum environment. The support can be using mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device.”

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “lens” herein may be considered as synonymous with the more general term “projection system.”

The illumination system may also encompass various types of optical components, including refractive, reflective, and catadioptric optical components for directing, shaping, or controlling the projection beam of radiation, and such components may also be referred to below, collectively or singularly, as a “lens.”

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g., water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a lithographic apparatus according to a further embodiment of the invention;

FIG. 3(a) is a schematic diagram showing a system for modifying the projection beam bandwidth distribution;

FIG. 3(b) illustrates an example of how to determine a projection beam or laser bandwidth distribution is a symmetrical;

FIG. 3(c) is an example of symmetric projection beam or laser bandwidth distributions;

FIG. 3(d) is an example of asymmetric projection beam or laser bandwidth distributions;

FIG. 4 is simulated CDV pitch curves;

FIGS. 5(a) to (d) is a series of schematic diagrams showing splitting and recombination of the projection beam;

FIG. 6 is a schematic representation of a part of a Bossung curve;

FIG. 7 is a schematic representation of introduction of a wafer Rₓ tilt;

FIG. 8 is a schematic representation of introduction of a wafer Rₓ tilt;

FIG. 9 is a schematic representation illustrating an analogy of effect of wafer Rx tilt on focus history seen by a part of the wafer during scan and a normal exposure (no Rx tilt) but now with a no zero bandwidth laser pulse.

FIG. 10 is a symmetric laser bandwidth distribution converted linearly into a symmetric focus distribution;

FIG. 11 is a symmetric focus distribution approached by a block function;

FIG. 12 is an example of a part of a Bossung curve showing schematically the effect of wafer Rx tilt or laser bandwidth;

FIG. 13 is a schematic representation of a symmetric laser bandwidth in right focus range;

FIG. 14 is an asymmetric laser bandwidth distribution connected linearly into an asymmetric focus distribution;

FIG. 15 is an asymmetric laser bandwidth distribution;

FIG. 16 is a simulated effect of increased laser bandwidth symmetry for constant FWHM (Full Width Half Maximum);

FIG. 17 is a simulated effect of increased laser bandwidth symmetry for constant FWHM (Full Width Half Maximum);

FIG. 18 is a simulated effect of increased laser bandwidth symmetry for constant FWHM (Full Width Half Maximum);

FIG. 19 is an example of a part of a Bossung curve showing schematically the effect of wafer Rx tilt or laser bandwidth.

### DETAILED DESCRIPTION OF THE DRAWINGS

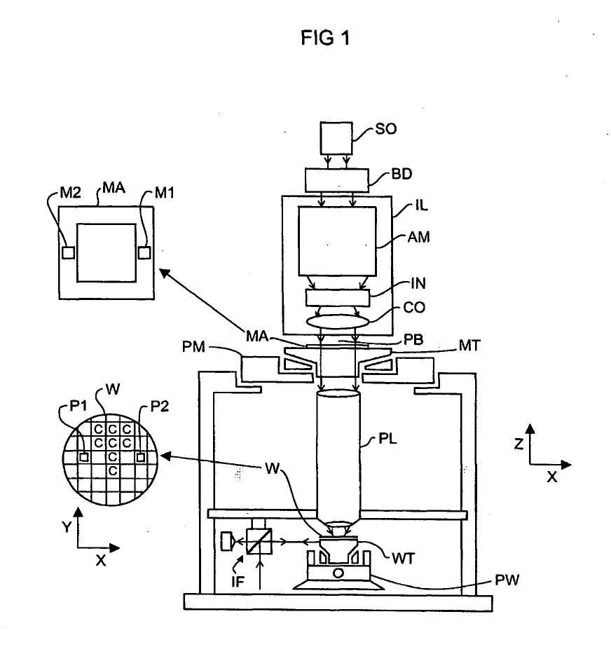

FIG. 1 schematically depicts a lithographic apparatus according to a particular embodiment of the invention. The apparatus comprises:
an illumination system (illuminator) IL for providing a projection beam PB of radiation (e.g., UV radiation or EUV radiation).
a first support structure (e.g., a mask table) MT for supporting a patterning device (e.g., a mask) MA and connected to first positioner PM for accurately positioning the patterning device with respect to item PL;
a substrate table (e.g., a wafer table) WT for holding a substrate (e.g., a resist-coated wafer) W and connected to second positioner PW for accurately positioning the substrate with respect to item PL; and
a projection system (e.g., a refractive projection lens) PL for imaging a pattern imparted to the projection beam PB by patterning device MA onto a target portion C (e.g., comprising one or more dies) of the substrate W.

As here depicted, the apparatus is of a transmissive type (e.g., employing a transmissive mask). Alternatively, the apparatus may be of a reflective type (e.g., employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjustable optical element(s) AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation, referred to as the projection beam PB, having a desired uniformity and intensity distribution in its cross-section.

The projection beam PB is incident on the mask MA, which is held on the mask table MT. Having traversed the mask MA, the projection beam PB passes through the lens PL, which focuses the beam onto a target portion C of the substrate W. With the aid of the second positioner PW and position sensor IF (e.g., an interferometric device), the substrate table WT can be moved accurately, e.g., so as to position different target portions C in the path of the beam PB. Similarly, the first positioner PM and another position sensor (which is not explicitly depicted in FIG. 1) can be used to accurately position the mask MA with respect to the path of the beam PB, e.g., after mechanical retrieval from a mask library, or during a scan. In general, movement of the object tables MT and WT will be realized with the aid of a long-stroke module (coarse positioning) and a short-stroke module (fine positioning), which form part of the positioners PM and PW. However, in the case of a stepper (as opposed to a scanner) the mask table MT may be connected to a short stroke actuator only, or may be fixed. Mask MA and substrate W may be aligned using mask alignment marks M1, M2 and substrate alignment marks P1, P2.

The depicted apparatus can be used in the following preferred modes:

1. In step mode, the mask table MT and the substrate table WT are kept essentially stationary, while an entire pattern imparted to the projection beam is projected onto a target portion C in one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the projection beam is projected onto a target portion C (i.e., a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the projection beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

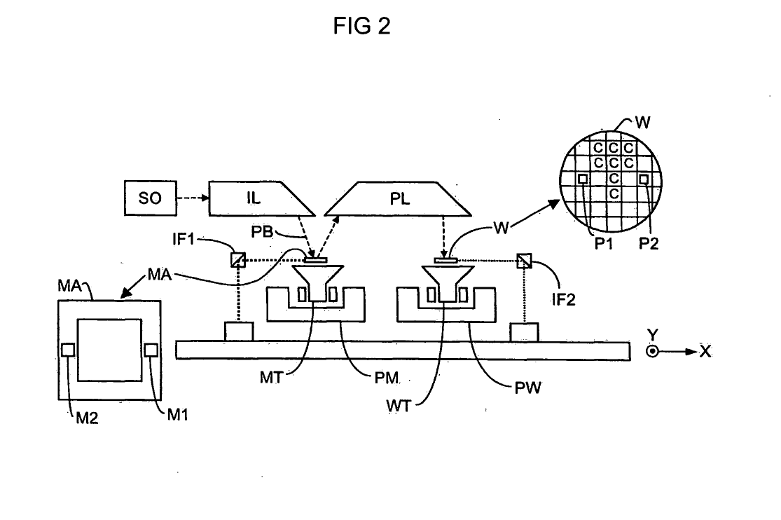

FIG. 2 schematically depicts a lithographic apparatus according to one embodiment of the invention. The apparatus of FIG. 2, in contrast to the apparatus in FIG. 1, is of a reflective type (e.g., employing a reflective mask).

The apparatus of FIG. 2 comprises:
an illumination system (illuminator) IL configured to condition a radiation beam B (e.g., UV radiation or EUV radiation);
a support structure (e.g., a mask table) MT constructed to support a patterning device (e.g., a mask) MA and connected to a first positioner PM configured to accurately position the patterning device in accordance with certain parameters;
a projection system (e.g., a refractive projection lens system) PS configured to project a pattern imparted to the radiation beam B by patterning device MA onto a target portion C (e.g., comprising one or more dies) of the substrate W.

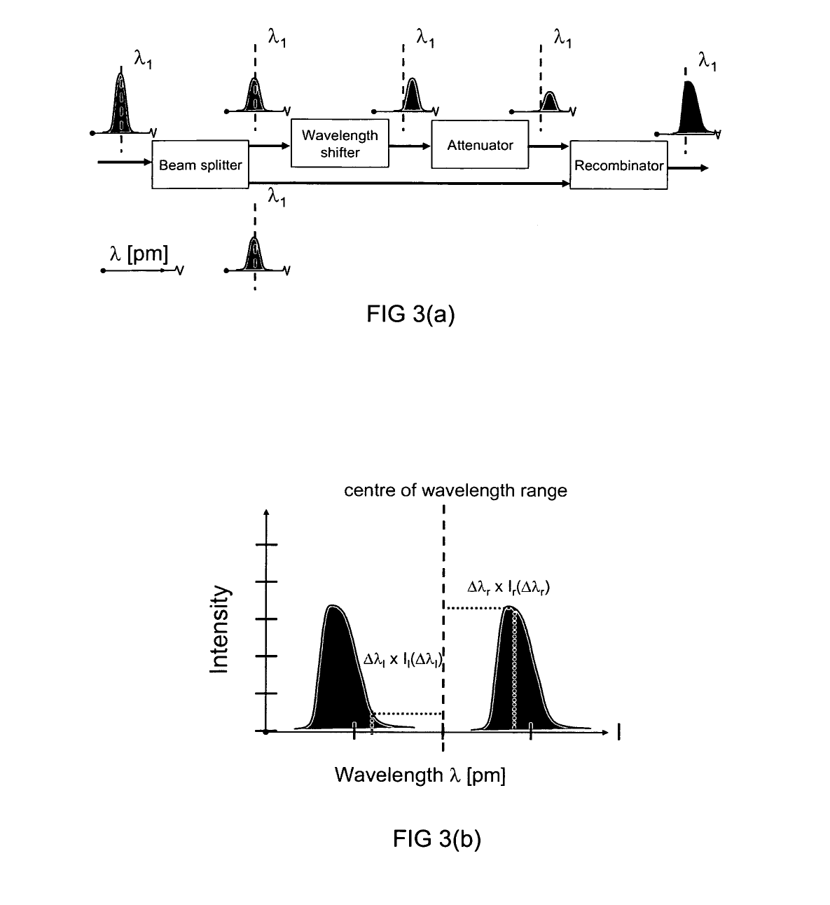

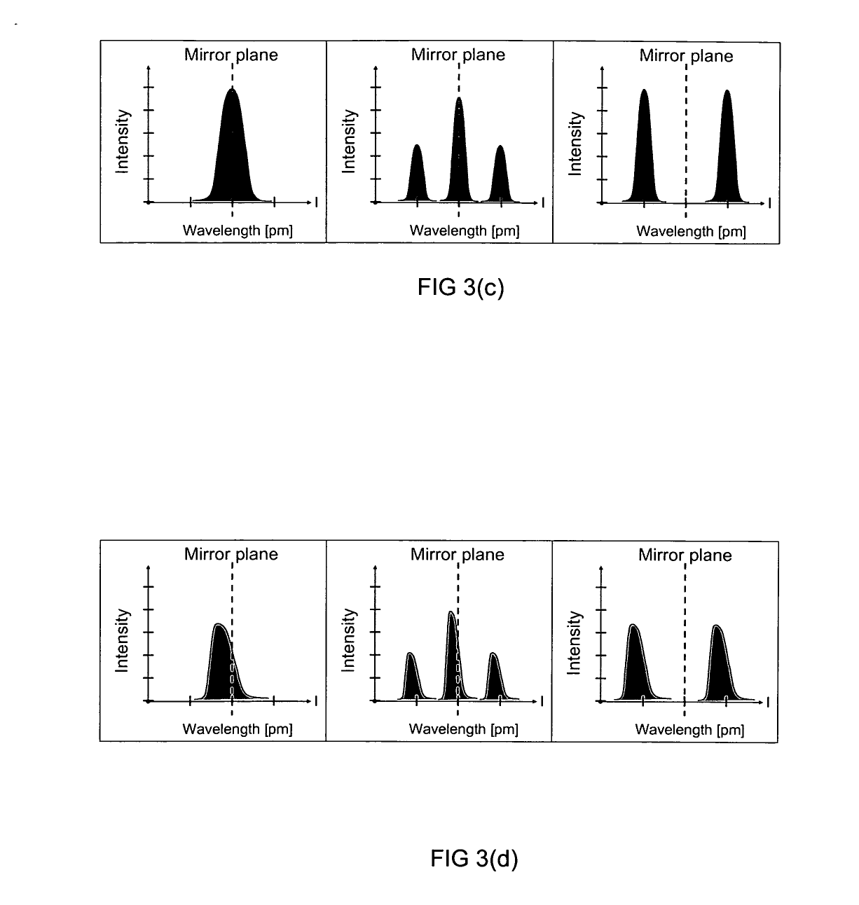

Laser bandwidth differences between systems results in optical proximity differences between systems, and for example, relative differences in iso-dense bias characteristics. Referring to FIG. 3(a), the present invention seeks to address such by providing a system for modifying the projection beam bandwidth distribution which system is implemented by a beam splitter comprising a beam splitter, beam wavelength altering member and an attenuator comprising a wavelength shifter and attenuator, and beam recombining element(s) (see FIG. 3(a)). Such are advantageously provided within the illumination system. The modified distribution may be asymmetric.

Referring to FIG. 3(b), there is shown an example of how to determine whether a projection beam or laser bandwidth distribution is asymmetrical. Note
I_{left}=∫Δλₗ×Iₗ(Δλₗ)dΔλₗ and I_{right}=∫Δλᵣ×Iᵣ(Δλᵣ)dΔλᵣ.

FIG. 3(c) shows an example of symmetric projection beam or laser bandwidth distributions.

FIG. 3(d) shows an example of asymmetric projection beam or laser bandwidth distributions.

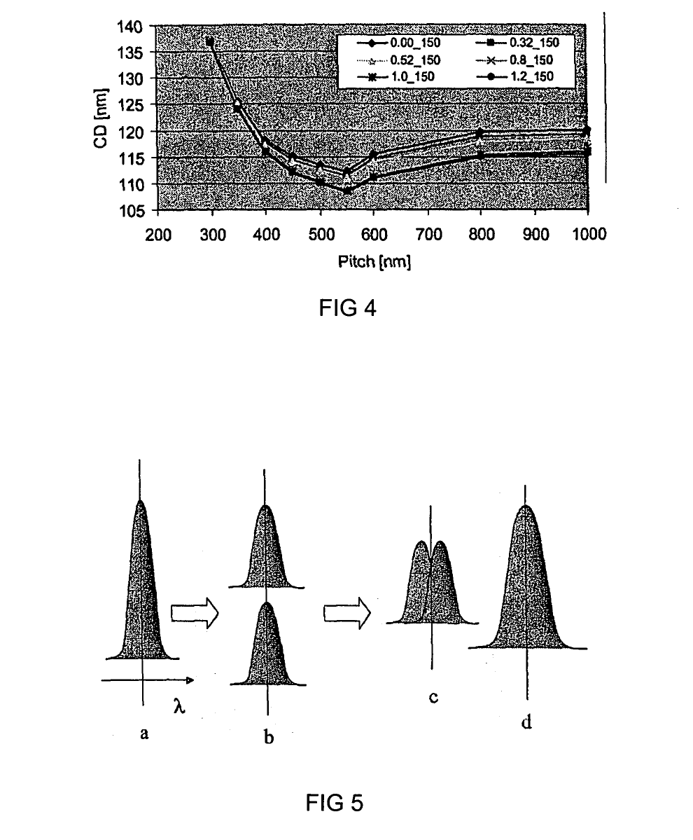

Referring to FIG. 4 there is shown simulated CD against pitch curves (proximity to curves) of 150 nm, and different bandwidths (varying from 0 to 1.2 pm).

Referring to FIGS. 5(a) to (d) there are shown a sequence of diagrams illustrating splitting a symmetrical spectrum (a) into two spectra (b) with a slightly different wavelength (c). The sum is a spectrum with a slightly lower intensity, but broader bandwidth distribution (d).

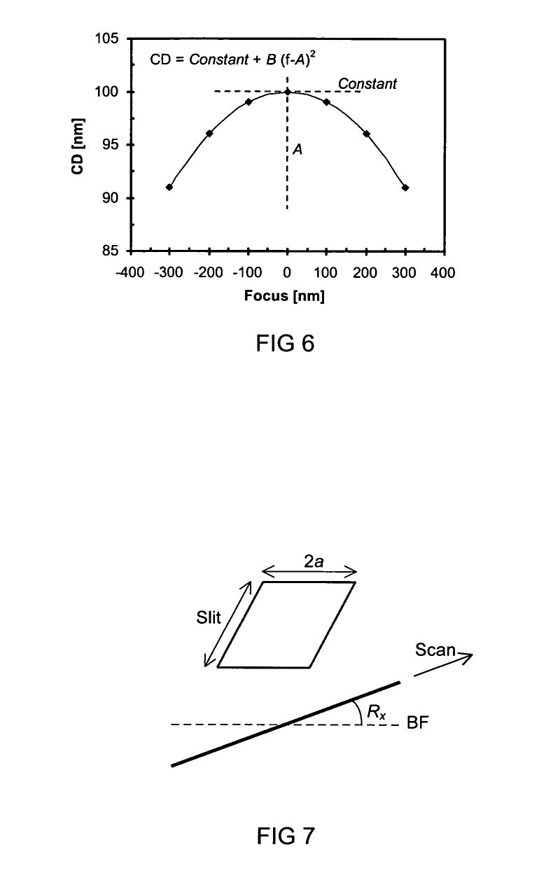

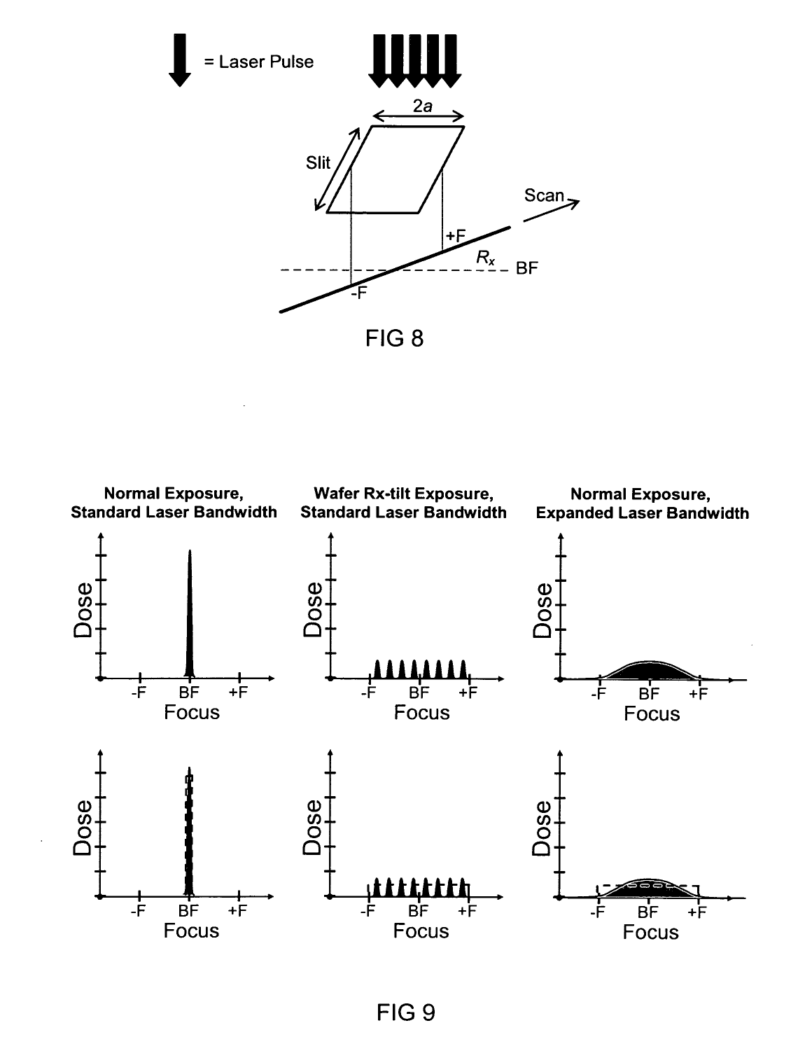

Referring to FIG. 6 there is shown a schematic representation of a part of a Bossung curve (CD through focus at constant energy) assuming a quadratic behaviour in focus for the CD change. Note that the constant A is parameter describing the Best Focus (BF) position.

Referring to FIG. 7, there are shown schematic representations of introduction of a wafer Rx tilt. In scan direction each point of the wafer sees a through focus behavior ranging from −a·Rₓ to a·Rₓ (2a is slit width).

Referring to FIG. 9, there is shown a schematic representation of effect of wafer-Rx tilt and laser bandwidth stretching on focus and dose seen by the structure to be imaged as compared to normal exposure.

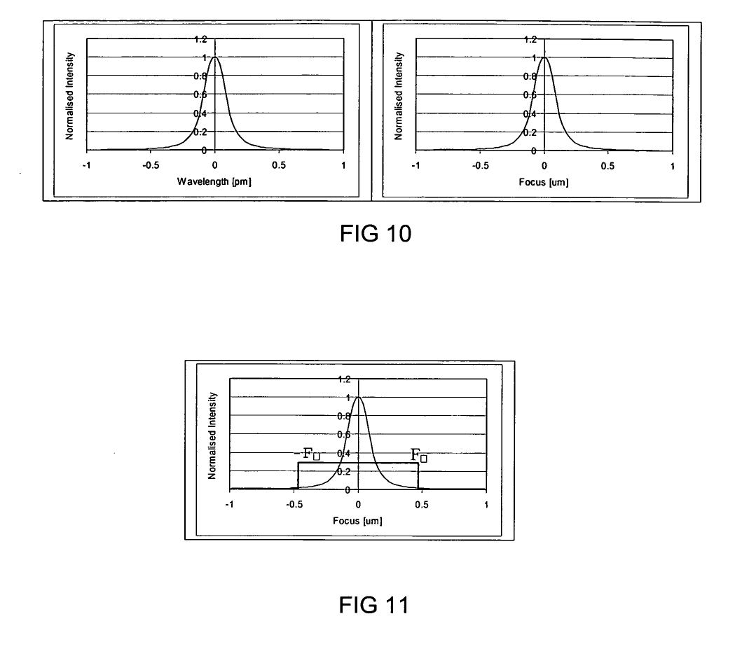

Referring to FIG. 10 there is shown a symmetric laser bandwidth distribution converted linearly into a symmetric focus distribution using the lens dependency dF/dλ. The energy of a laser is not confined to a single wavelength but to a continuous range of frequencies thus forming a wavelength spectrum with a certain bandwidth. Over a fairly wide range of wavelengths the laser spectrum can be converted linearly into a focus spectrum using the lens dependency dF/dλ (see FIG. 1a US 2002/0048288 A1).

A finite laser bandwidth results in the re-distribution of the aerial image through focus. The total aerial image will be a sum of the aerial images at each focal position, weighted by the relative intensity of each wavelength in the illumination spectrum (see US 2002/0048288 A1, 0028).

For simplicity it will be assumed that the laser spectrum can be approached by a block function. Referring to FIG. 11, it can be seen that a symmetric focus distribution is approached by a block function.

The average CD (at best focus) of a feature due to the introduction of a finite laser bandwidth resulting in the re-distribution of the aerial image over a focus range of from ½F_{□} to ½F_{□} (using the information as presented in FIG. 11) is given by:

$$\overline{CD} = \frac{{\int }_{- 1 / 2 {F}_{λ}}^{1 / 2 {F}_{λ}} C + B \cdot {f}^{2} ⅆ f}{{\int }_{- 1 / 2 {F}_{λ}}^{1 / 2 {f}_{λ}} ⅆ f} = \frac{C \cdot f + B \cdot \frac{1}{3} {f}^{3} {\vert}_{- 1 / 2 {F}_{λ}}^{1 / 2 {F}_{λ}}}{f {\vert}_{- 1 / 2 {F}_{λ}}^{1 / 2 {F}_{λ}}} = \frac{C \cdot {F}_{λ} + B \cdot \frac{2}{3} {( 1 / 2 {F}_{λ} )}^{3}}{{F}_{λ}} = C + B \cdot \frac{1}{12} {F}_{λ}^{2}$$

From the above equation it is clear that the ΔCD due to the introduction of a certain laser bandwidth resulting in a through focus re-distribution of the image over a focus range from ½F_{□} to ½F_{□} is given by:

$$Δ CD = B \cdot \frac{1}{12} {F}_{λ}^{2} ∼ {F}_{λ}^{2}$$

Assuming that the energy dependence of the CD is focus independent (so ∂CD/∂E≠F(f)) the impact of laser bandwidth on CD can be easily compensated in order to maintain the CD of the reference feature unaltered.

The equation for the CD change due to re-distribution of the aerial image over a focus range from ½F_{□} to ½F_{□} can be generalized for an arbitrary focus position F as follows:

$$\overline{CD} = \frac{{\int }_{F - 1 / 2 {F}_{λ}}^{F + 1 / 2 {F}_{λ}} C + B \cdot {f}^{2} ⅆ f}{{\int }_{F - 1 / 2 {F}_{λ}}^{F + 1 / 2 {f}_{λ}} ⅆ f} = \frac{C \cdot f + B \cdot \frac{1}{3} {f}^{3} {\vert}_{F - 1 / 2 {F}_{λ}}^{F + 1 / 2 {F}_{λ}}}{f {\vert}_{F - 1 / 2 {F}_{λ}}^{F + 1 / 2 {F}_{λ}}} = \frac{C \cdot {F}_{λ} + B \cdot \frac{1}{3} ( 6 {F}^{2} \cdot \frac{1}{2} {F}_{λ} + 2 {( \frac{1}{2} {F}_{λ} )}^{3} )}{{F}_{λ}} = C + B \cdot \frac{1}{3} ( 3 {f}^{2} + \frac{1}{4} {F}_{λ}^{2} )$$

Rewriting this equation and generalizing it for all for Focus f results in:
CD=C+B·f²+B· 1/12F_{λ}²

The shift in CD induced by the re-distribution of the aerial image over a focus range from ½F_{□} to ½F_{□} is independent of the focus position and is proportional with F_{□}².

For a fourth order focus term can be derived:

$$\overline{CD} = \frac{{\int }_{F - 1 / 2 {F}_{λ}}^{F + 1 / 2 {F}_{λ}} E \cdot {f}^{4} ⅆ f}{{\int }_{F - 1 / 2 {F}_{λ}}^{F + 1 / 2 {f}_{λ}} ⅆ f} = \frac{E \cdot \frac{1}{5} {f}^{3} {\vert}_{F - 1 / 2 {F}_{λ}}^{F + 1 / 2 {F}_{λ}}}{f {\vert}_{F - 1 / 2 {F}_{λ}}^{F + 1 / 2 {F}_{λ}}} = \frac{E \cdot \frac{1}{5} ( 10 a \cdot {R}_{x} \cdot {f}^{4} + 20 {( \frac{1}{2} {F}_{λ} )}^{3} \cdot {F}^{2} + 2 {( \frac{1}{2} {F}_{λ} )}^{5} )}{{F}_{λ}} = E \cdot ( {f}^{4} + \frac{1}{2} {F}_{λ}^{2} \cdot {f}^{2} + \frac{1}{80} {F}_{λ}^{4} )$$

For a first order focus term can be derived:

$$\overline{CD} = \frac{{\int }_{F - 1 / 2 {F}_{λ}}^{F + 1 / 2 {F}_{λ}} D \cdot {f}^{1} ⅆ f}{{\int }_{F - 1 / 2 {F}_{λ}}^{F + 1 / 2 {f}_{λ}} ⅆ f} = \frac{D \cdot \frac{1}{2} {f}^{2} {\vert}_{F - 1 / 2 {F}_{λ}}^{F + 1 / 2 {F}_{λ}}}{f {\vert}_{F - 1 / 2 {F}_{λ}}^{F + 1 / 2 {F}_{λ}}} = \frac{D \cdot \frac{1}{2} ( 2 {F}_{λ} \cdot f )}{{F}_{λ}} = D \cdot ( F )$$

So the re-distribution of the aerial image over a focus range from −½F_{□} to ½F_{□} does not impact the linear focus term.

The equation for the CD change due to the re-distribution of the aerial image over a focus range from −½F_{□} to ½F_{□} can be generalized for an arbitrary focus position F as follows:

$$\overline{CD} = \frac{{\int }_{F - 1 / 2 {F}_{λ}}^{F + 1 / 2 {F}_{λ}} C + B \cdot {f}^{2} ⅆ f}{{\int }_{F - 1 / 2 {F}_{λ}}^{F + 1 / 2 {f}_{λ}} ⅆ f} = \frac{C \cdot f + B \cdot \frac{1}{3} {f}^{3} {\vert}_{F - 1 / 2 {F}_{λ}}^{F + 1 / 2 {F}_{λ}}}{f {\vert}_{F - 1 / 2 {F}_{λ}}^{F + 1 / 2 {F}_{λ}}} = \frac{C \cdot {F}_{λ} + B \cdot \frac{1}{3} ( 6 {f}^{2} \cdot \frac{1}{2} {F}_{λ} + 2 {( \frac{1}{2} {F}_{λ} )}^{3} )}{{F}_{λ}} = C + B \cdot \frac{1}{3} ( 3 {F}^{2} + \frac{1}{4} {F}_{λ}^{2} )$$

Rewriting this equation and generalizing it for all for Focus f results in:

$$CD = C + B \cdot {f}^{2} + B \cdot \frac{1}{12} {F}_{λ}^{2}$$

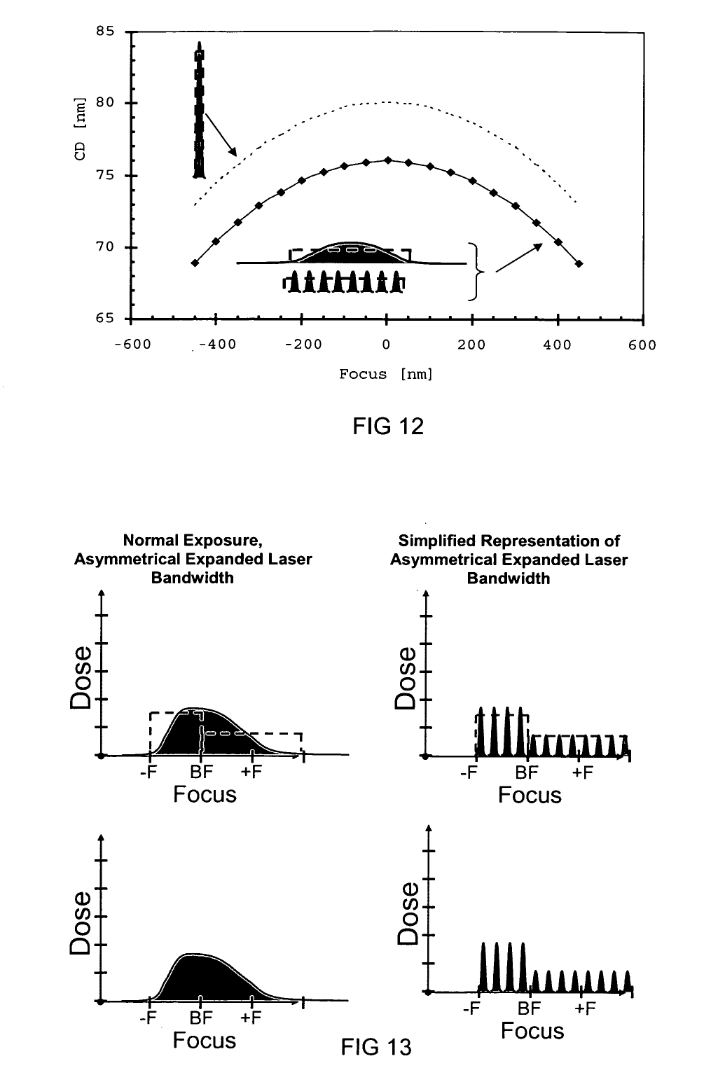

Referring to FIG. 12, there is shown an example of a part of a Bossung curve (CD versus focus as function of energy (iso-energy line is depicted)) showing the impact of a symmetric laser bandwidth increase as compared to normal exposure.

Turning now the asymmetrical situation. Assume that it is possible to create an aerial image with an asymmetric focus history see FIG. 13. Also here for simplicity it will be assumed that the laser spectrum can be approached by a block function.

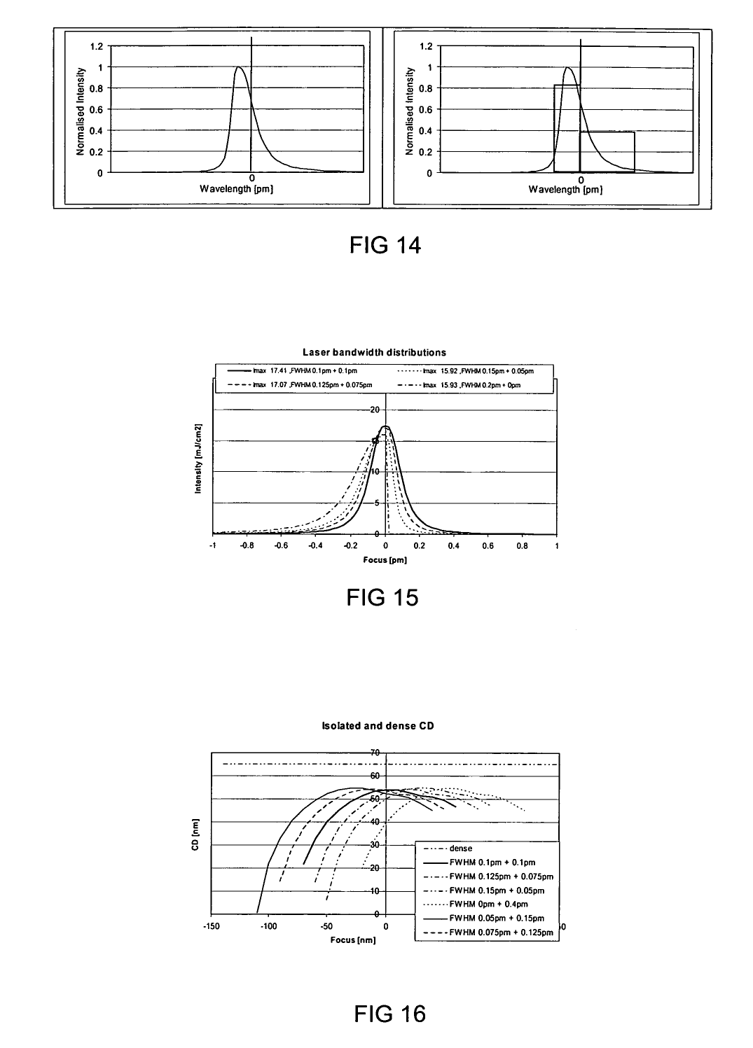

Referring to FIG. 14 it can be seen that an asymmetric laser bandwidth distribution is converted linearly into an a-symmetric focus distribution using the lens dependency dF/dλ. The a-symmetric focus distribution is approached by two block functions.

FIG. 13 shows a schematic representation of asymmetric laser bandwidth right focus range is twice the left focus range having both the same dose.

Considering FIG. 12 and FIG. 13 the effect of asymmetric laser bandwidth on a Bossung curve can be estimated using the procedure as described above.

Now the quadratic CD (CD=C+B·f²) for an arbitrary focus position F becomes:

$$\overline{CD} = \frac{1}{2} \frac{{\int }_{F - 1 / 2 {F}_{λ}}^{F} C + B \cdot {f}^{2} ⅆ f}{{\int }_{F - 1 / 2 {F}_{λ}}^{{F}_{λ}} ⅆ f} + \frac{1}{2} \frac{{\int }_{F}^{F + {F}_{λ}} C + B \cdot {f}^{2} ⅆ f}{{\int }_{F}^{F + {F}_{λ}} ⅆ f} = \frac{{\int }_{F - 1 / 2 {F}_{λ}}^{F + {F}_{λ}} C + B \cdot {f}^{2} ⅆ f}{{\int }_{F - 1 / 2 {F}_{λ}}^{F + {F}_{λ}} ⅆ f} = \frac{C \cdot f + B \cdot \frac{1}{3} {f}^{3} {\vert}_{F - 1 / 2 {F}_{λ}}^{F + {F}_{λ}}}{f {\vert}_{F - 1 / 2 {F}_{λ}}^{F + {F}_{λ}}} = \frac{C \cdot 3 a \cdot {R}_{x} + B \cdot \frac{1}{3} ( {( f + {F}_{λ} )}^{3} - {( f - \frac{1}{2} {F}_{λ} )}^{3} )}{\frac{3}{2} {F}_{λ}} = \frac{C \cdot \frac{3}{2} {F}_{λ} + B \cdot \frac{1}{3} ( 3 {f}^{2} \cdot \frac{3}{2} {F}_{λ} + 3 f \cdot 3 {( \frac{1}{2} {F}_{λ} )}^{2} + 9 {( \frac{1}{2} {F}_{λ} )}^{3} )}{3 \frac{1}{2} {F}_{λ}} = C + B \cdot \frac{1}{3} ( 3 {f}^{2} + \frac{3}{2} f \cdot {F}_{λ} + \frac{3}{4} {F}_{λ}^{2} )$$

Rewriting this equation and generalizing it for all for Focus f results in:

$$CD = C + B \cdot {f}^{2} + \frac{1}{2} B \cdot f \cdot {F}_{λ} + \frac{1}{4} B \cdot {F}_{λ}^{2}$$

Now not only an offset is introduced (as is the case for a symmetric focus history) but also a linear term. This results in a tilt of the Bossung curve.

This tilt could be used to compensate for IDB. The impact of laser bandwidth is shown by way of simulations. FIG. 15 shows an asymmetric laser bandwidth distribution. For the simulations these laser bandwidth distributions were approximated.

FIG. 16 shows the simulated effect of increased laser bandwidth asymmetry for constant FWHM (Full Width Halve Maximum=0.2 pm) for nominal 65 nm dense and isolated lines (Prolith 5 pass calculation, NA 0.93 and sigma 0.94/0.74, binary reticle, calibrated resist model). Showing, as expected from the calculations, a shift in of the Bossung curve in focus and change of the Bossung tilt. Note all calculations were performed using the same exposure dose.

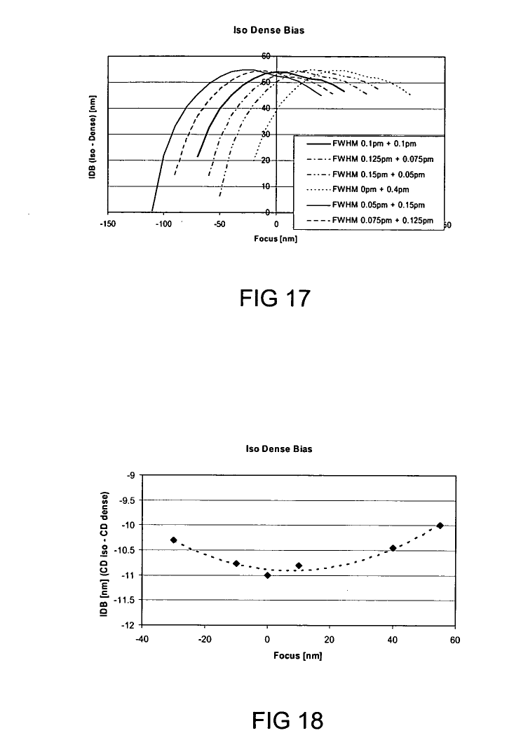

FIG. 17 shows the effect of increased laser bandwidth asymmetry for constant FWHM (Full Width Halve Maximum=0.2 pm) 65 nm iso dense bias, IDB (Prolith 5 pass calculation, NA 0.93 and sigma 0.94/0.74, binary reticle, calibrated resist model).

Final FIG. 18 shows simulated effect of increased laser bandwidth asymmetry for constant FWHM (Full Width Halve Maximum=0.2 pm) 65 nm iso dense bias, IDB. Showing the impact on iso dense bias when correcting for the focus offset introduced by the laser bandwith asymmetry. The magnitude of the impact is application dependent (feature size and shape, resist and illumination conditions/mode).

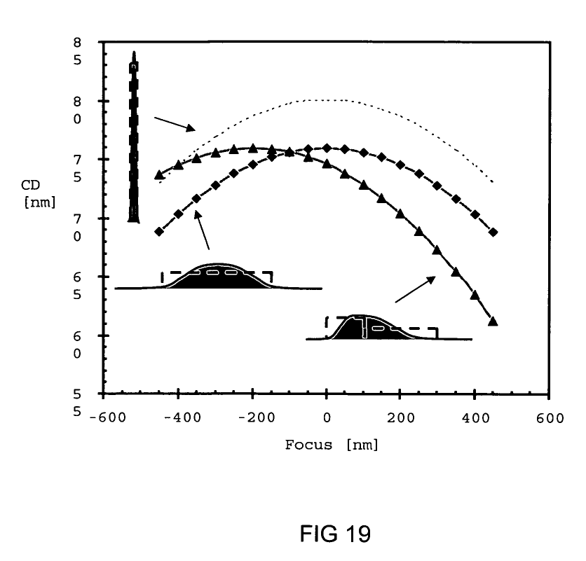

Referring to FIG. 19, there is shown an example of a part of a Bossung curve (CD versus focus as function of energy (iso-energy line is depicted)) showing the impact of symmetrical and asymmetrical laser bandwidth increase as compared to normal exposure. Note for both the symmetrical and asymmetrical case the total focal range is the same.

While specific embodiments of the invention have been described above, it will be appreciated that the invention may be practiced otherwise than as described. The description is not intended to limit the invention. It will also be appreciated that the disclosed embodiments may include any of the features herein claimed.

1. A lithographic apparatus comprising:
an illumination system for providing a beam of radiation;
a support structure for supporting a patterning device, the patterning device serving to impart the projection beam with a pattern in its cross-section;
a substrate table for holding a substrate;
a projection system for projecting the beam onto a target portion of the substrate; and
a controller, configured and arranged to cause an energy spectrum of the beam of radiation to be modified.

2. A lithographic apparatus as claimed in claim 1, wherein, in use, the controller causes an increase in a width of the energy spectrum.

3. A lithographic apparatus as claimed in claim 1, wherein, in use, the controller causes a symmetrical energy spectrum to become asymmetrical.

4. A lithographic apparatus as claimed in claim 1, wherein the controller controls the energy spectrum thereby improving system-to-system imaging performance.

5. A lithographic apparatus as claimed in claim 1, wherein the energy spectrum is modified by superimposing two wavelength spectra with a wavelength difference, substantially a same bandwidth and a same intensity.

6. A lithographic apparatus as claimed in claim 1, wherein the controller controls a source of the beam of radiation.

7. A lithographic apparatus as claimed in claim 1, wherein the controller controls optical elements comprising a portion of the illumination system.

8. A lithographic apparatus as claimed in claim 1, further comprising:
a beamsplitter constructed and arranged to divide the beam of radiation into two sub-beams;
a wavelength shifter constructed and arranged to shift an energy spectrum of one of the sub-beams to form a shifted sub-beam;
an attenuator constructed and arranged to attenuate the shifted sub-beam; and
a beam recombinator constructed and arranged to re-combine the sub-beams.

9. A lithographic apparatus as claimed in claim 8, wherein the controller controls one or more of the beamsplitter, the wavelength shifter, the attenuator or the beam recombinator to cause the energy spectrum of the beam of radiation to be modified.

10. A lithographic apparatus as claimed in claim 1, wherein the projection beam is modified by superimposing two wavelength spectra selected from the group consisting of:
two wavelength spectra having a wavelength difference with different bandwidth and substantially a same intensity;
two wavelength spectra having a wavelength difference and with substantially a same bandwidth and different intensities; and
two wavelength spectra having a wavelength difference, different bandwidth and different intensities.

11. A lithographic apparatus as claimed in claim 10, wherein the wavelength difference is selected from the group consisting of between 0 and 1 pm, and between 0 and 0.5 pm.

12. A lithographic apparatus as claimed in claim 10, wherein
$$1.1 \leq \frac{\vert {I}_{left} \vert}{\vert {I}_{right} \vert} or 0.9 \geq \frac{\vert {I}_{left} \vert}{\vert {I}_{right} \vert}$$
where I_{left} is an intensity of a first of the two wavelength spectra, and I_{right} is an intensity of a second of the wavelength spectra.

13. A lithographic apparatus as claimed in claim 1, wherein the projection beam comprises at least two wavelength spectra which are exposed upon the substrate substantially simultaneously.

14. A lithographic apparatus as claimed in claim 1, wherein the projection beam comprises at least two wavelength spectra which are exposed upon the substrate sequentially.

15. A lithographic apparatus as claimed in claim 1, wherein the projection beam has a wavelength selected from the group consisting of: about 20 to 50 nm, 50 to 500 nm, 100 to 400 nm, about 126 nm, about 157 nm, about 193 nm, about 248 nm and about 365 nm.

16. A device manufacturing method comprising:
patterning a beam of radiation with a pattern in its cross-section;
projecting the patterned beam of radiation onto a target portion of a substrate; and
controlling an energy spectrum of the beam of radiation to change the energy spectrum thereby modifying image contrast.

17. A device manufacturing method as claimed in claim 16, wherein the controlling further comprises controlling optical components of an illumination system of a lithography apparatus used in the method.

18. A device manufacturing method as claimed in claim 16, wherein the controlling further comprises:
splitting the beam of radiation into two sub-beams;
shifting an energy spectrum of one of the sub-beams to form a shifted sub-beam;
attenuating the shifted sub-beam; and
re-combining the sub-beams.

19. A device manufacturing method as claimed in claim 16, wherein the controlling further comprises superimposing two wavelength spectra selected from the group consisting of:
two wavelength spectra having a wavelength difference with different bandwidth and substantially a same intensity;
two wavelength spectra having a wavelength difference and with substantially a same bandwidth and different intensities; and
two wavelength spectra having a wavelength difference, different bandwidth and different intensities.

20. A microelectronic device manufactured according to the method of claim 16.
